(19) United States
(12) Patent Application Publication
(10) Pub. No.: US 2004/0110302 A1
(43) Pub. Date: Jun. 10, 2004

(54) Method for the marking of mineral oil

(76) Inventors: Christos Vamvakaris, Mannheim (DE); Patrik Schneider, Schwalbach (DE); Gerhard Wagenblast, Wachenheim (DE); Roland Merger, Bad Schonborn (DE); Claudia Krah, Mutterstadt (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/450,451

(22) PCT Filed: Dec. 19, 2001
(86) PCT No.: PCT/EP01/15044

(30) Foreign Application Priority Data
Dec. 20, 2000 (DE) 10063955.0

(51) Int. Cl. G01N 37/00

(52) U.S. Cl. 436/56

(57) ABSTRACT

In a method of marking hydrocarbons by addition of at least one first marker, at least one second marker which cannot be removed completely from the hydrocarbons under the conditions of the removal of the first marker or markers is additionally added to the hydrocarbons.

Hydrocarbons which have been marked by such a method and solutions comprising at least one first marker and at least one second marker as defined in the method of the present invention and also, if desired, further additives for marking hydrocarbons are also provided by the invention.

The present invention relates to a method of marking hydrocarbons by addition of at least one first marker, in which at least one second marker which cannot be removed completely from the hydrocarbons under the conditions of the removal of the first marker or markers is additionally added to the hydrocarbons.

The invention also relates to hydrocarbons which have been marked by such a method, and also to solutions for marking hydrocarbons, which solutions comprise at least one first marker and at least one second marker as defined in the method of the present invention plus, if desired, further additives.

The marking of hydrocarbons, e.g. of products from petroleum refining, is generally carried out for tax reasons, since one and the same product can be taxed differently depending on the purpose for which it is used. Thus, heating oil is generally marked since it is subject to lower tax than diesel oil which has an identical composition. However, the difference in price between heating oil and diesel fuel results in a corresponding incentive for diesel fuel to be illegally blended with heating oil or for heating oil to be used as diesel fuel after removal of the marker.

A variety of marking methods and markers or marker mixtures have been proposed for marking hydrocarbons, in particular mineral oils.

Thus, for example, acid-extractable markers suitable for hydrocarbons or mineral oils are described in EP 0 519 270, EP 0 679 710, EP 0 803 563, EP 0 989 164, WO 94/11466, WO 95/07460, WO 95/17483 and U.S. Pat. No. 4,209,302, and acid-extractable dyes which can also be used as markers are described in DE-A 2 129 590.

Markers which can be extracted under basic conditions are described in U.S. Pat. No. 3,764,273, U.S. Pat. No. 5,252,106, EP 0 509 818, WO 94/21752 and WO 95/10581.

The markers are generally detected visually by concentrating them in the extract and/or by reaction with suitable reagents to form colored reaction products. WO 94/02570, WO 99/56125, WO 99/558051, U.S. Pat. No. 5,525,516 and U.S. Pat. No. 5,710,046 describe methods of marking hydrocarbons or mineral oils with markers which absorb or fluoresce in the infrared region of the spectrum and can be detected in this way.

A serious disadvantage of marking methods in which the detection of the marker is associated with an extraction step is that precisely such an extraction method also allows the illegal removal of the marker by third parties.

It is an object of the present invention to provide a method of marking hydrocarbons which makes it possible to detect the marking even after removal of the first marker(s) and/or makes the removal of the marking economically nonviable.

We have found that this object is achieved by the method of marking hydrocarbons described at the outset.

In particular, at least one second marker whose absorption maximum is at a wavelength below 500 nm is employed in the method of the present invention. Second markers having such absorption behavior are thus difficult or impossible to detect visually in most hydrocarbons, particularly in mineral oils, especially when they are added in the customary amounts.

For the purposes of the present invention, hydrocarbons are products in general which are obtained in petroleum refining. They include, for example, propane, butane, pentane, hexane, heptane, octane, isooctane, benzene, toluene, xylene, ethylbenzene, tetralin, decalin or dimethylnaphthalene. In particular, they are mineral oils, for example fuels such as gasoline, kerosene or diesel fuel, or oils such as heating oil or motor oil.

Furthermore, they also include products as are obtained by processing of certain types of plant, e.g. oilseed rape or sunflowers. Such products are also known as “bio-diesel”.

Under normal conditions, the hydrocarbons are generally present in a liquid or gaseous state. Gaseous hydrocarbons, e.g. propane or butane, can be converted into the liquid form by, for example, compression.

It may be noted here that such hydrocarbons are frequently additionally colored by means of (solvent) dyes. This allows, for example in the mineral oil sector, direct visual recognition of the manufacturer from which the respective mineral oil product comes or of the fiscal classification to which it is subject. However, such “color coding” is not marking in the sense of the present invention. In contrast, markers used are usually substances which are not directly recognizable visually, but can be detected only by the specific detection method. Although such markers may also be colored, but are then, owing to their usually low concentration in the hydrocarbon, obscured either by the intrinsic color of the hydrocarbon or by the color of added (solvent) dye(s).

The property of the second marker of “not being able to removed completely from the hydrocarbons under the conditions of the removal of the first marker or markers” means that removal of the first marker always leaves a detectable residual concentration of the second marker in the hydrocarbon. This residual concentration may usually be assumed to be at least 25% of the initial concentration, so that the second marker can still be detected reliably after removal of the first marker even at an appropriately low concentration of the second marker. However, the concentration can fall below this minimum concentration in some cases. This is the case, for example, when a particularly sensitive detection method is available for the second marker concerned.

For the purposes of the present invention, “removal” of the first marker is any chemical and/or physical process which leads to complete or virtually complete elimination of the first marker. Such processes may be separation of the first marker from the hydrocarbon by chromatic methods, extraction processes using various solvents or solvent mixtures, distillation processes or filtration methods using materials which adsorb such first markers, or oxidative or reductive destruction or photolytic decomposition of the first marker, with or without the additional action of oxidants such as (atmospheric) oxygen. The first marker can also have been converted beforehand into a derivative which is then removed from the hydrocarbon by physical or chemical processes.

According to the present invention, the physical and/or chemical processes mentioned above by way of example for removal of the first marker have to leave a sufficient amount of the second marker for it to be detected.

The formulation “complete or virtually complete elimination” means, for the purposes of the present invention, that the first marker is no longer recognizable, for example, visually in the hydrocarbon but was before its elimination, that the first marker can no longer be recognized by means of optical detection methods, e.g. fluorescence detectors, but was previously, or that detection of this marker is no longer possible by the extraction and optionally derivative formation process intended for this purpose is no longer possible although it was previously.

In a preferred embodiment of the method of the present invention, the first marker or markers can be removed under acidic or basic conditions and the second marker or markers cannot be removed completely in a corresponding fashion under acidic or basic conditions or the second marker or markers can be removed completely from the hydrocarbons under neither acidic nor basic conditions.

If, in this preferred embodiment, the first marker can be removed under acidic conditions, then the second marker cannot be removed completely under acidic conditions or both under acidic and basic conditions. In the latter case, the hydrocarbons marked by the method of the present invention can also not be freed of the second marker by a combination of acidic and subsequent basic treatment. An analogous situation applies to the case of the first marker being able to be removed under basic conditions.

For the present purposes, “acidic” or “basic” conditions are, in particular, the action of substances having Brönsted and/or Lewis acid or basic character on the hydrocarbons admixed with the marker(s).

Acidic substances in this sense are, for example, gaseous hydrogen halides, e.g. hydrogen chloride or hydrogen bromide, and gaseous hydrogen sulfide and also the corresponding solutions in, for example, water, alcohols and ethers, gaseous sulfur dioxide and gaseous or solid sulfur trioxide and also the corresponding solutions in, for example, water, alcohols and ethers, solvent-free sulfuric, nitric or phosphoric acid and also the corresponding solutions in, for example, water, alcohols and ethers, ammonium salts and their solutions, for example in water, alcohols and ethers, gaseous or liquid carbon dioxide and also its solutions, for example in water and, if desired, alcohols and ethers, and Lewis-acid metal halides, e.g. magnesium, titanium, iron, copper, zinc, aluminum or silicon chlorides or bromides, and also, where possible, the corresponding solutions in, for example, water, alcohols and ethers.

Basic substances in the abovementioned sense are, for example, alkali metal and alkaline earth metal hydroxides, hydrogencarbonates and carbonates and alkali metal phosphates and also, where possible, the corresponding solutions in, for example, water, alcohols and ethers, alkali metal and alkaline earth metal hydrides, ammonia, primary, secondary and tertiary amines and also, where possible, the corresponding solutions in, for example, water, alcohols and ethers.

For the purposes of the present invention, “removable” under acidic or basic conditions means that the action of the acidic or basic substances mentioned above by way of example on the first marker converts it into a form which makes possible its complete or virtually complete elimination by some chemical and/or physical processes. This applies analogously to the removability or nonremovability of the second marker.

In a further preferred embodiment of the method of the present invention, the first marker or markers can be removed by means of aqueous acidic or aqueous basic extractants and the second marker or markers cannot be removed completely in a corresponding fashion by means of aqueous acidic or aqueous basic extractants, or the second marker or markers can be removed completely from the hydrocarbons neither by means of aqueous acidic extractants nor by means of aqueous basic extractants.

Acid-extractable markers which can be used as possible first markers for the purposes of this embodiment of the method of the present invention are described in the above-cited documents EP 0 519 270, EP 0 679 710, EP 0 803 563, EP 0 989 164, WO 94/11466, WO 95/07460, WO 95/17483, U.S. Pat. No. 4,209,302 and in DE-A 2 129 590.

In the following listing of acid-extractable markers, the definition of the respective variables has been adopted from the corresponding cited document for reasons of clarity. For specific meaning and preferred meanings of the variables, the disclosures of the respective documents are hereby expressly incorporated by reference.

Specific examples of possible acid-extractable markers are:

from EP 0 519 270, azo compounds of the formula

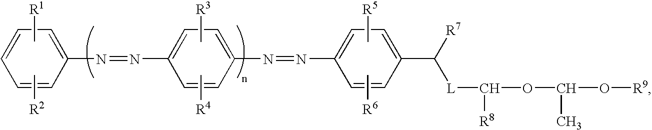

where n is zero or 1,

R¹, R², R³ and R⁵ are identical or different and are each, independently of one another, hydrogen, C₁-C₄-alkyl, C₁-C₄-alkoxy, halogen or nitro,

R⁴ and R⁶ are identical or different and are each, independently of one another, hydrogen, C₁-C₄-alkyl, C₁-C₄-alkoxy, halogen, nitro or C₁-C₄-alkanoylamino,

R⁷ is C₁-C₄-alkyl,

R⁸ is hydrogen or C₁-C₄-alkyl,

R⁹ is C₁-C₁₈-alkyl or cyclohexyl and

L is C₁-C₃-alkylene,

from EP 0 679 710, azo compounds of the formula

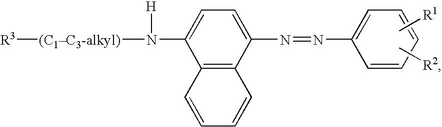

where R¹ and R² are selected from among hydrogen, methyl, ethyl, methoxy, halogen, cyano and nitro, and

R³ is selected from among methyl, methoxy, methoxyethoxy and morpholino,

from EP 0 803 563, azo compounds of the formula

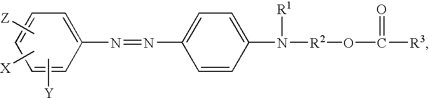

where R¹ is C₁-C₃-alkyl, R² is C₁-C₃-alkylene and R³ is C₁-C₂-alkyl,

X and Y are identical or different and are selected from among hydrogen, C₁-C₃-alkyl, C₁-C₃-alkoxy, halogen and nitro, and

Z is hydrogen or a group of the formula

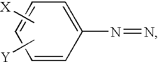

where X and Y are as defined above,

from EP 0 989 164, azo compounds of the formula

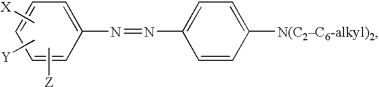

where X and Y are identical or different and are each selected from among hydrogen, methyl, ethyl, isopropyl, butyl, methoxy, galogen and nitro, and

Z is hydrogen or amino,

from WO 94/11466, anilines of the formula

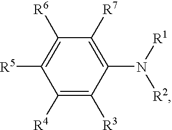

where R¹ and R² are each, independently of one another, hydrogen, C₁-C₁₈-alkyl which may be substituted or unsubstituted and may be interrupted by from 1 to 3 oxygen atoms as ether functions or by from 1 to 3 C₁-C₄-alkylimino groups, C₃-C₁₈-alkenyl, substituted or unsubstituted phenyl, or R¹ and R² together with the nitrogen atom connecting them form a 5- or 6-membered saturated heterocyclic radical which may contain a further heteroatom, or R¹ may also be a radical of the formula OL¹ or NL¹L², where L¹ and L² are each, independently of one another, hydrogen, substituted or unsubstituted C₁-C₁₈-alkyl, C₃-C₁₈-alkenyl or substituted or unsubstituted phenyl,

R³ and R⁷ are each, independently of one another, hydrogen, substituted or unsubstituted C₁-C₁₈-alkyl, C₂-C₁₈-alkenyl, cyano, nitro, formyl, substituted or unsubstituted C₂-C₄-alkanoyl, formylamino, substituted or unsubstituted C₂-C₄-alkanoylamino, benzoylamino or a radical of the formula OL¹, CH₂COOL¹, NL¹L², SL¹ or SO₂NL¹L², where L¹ and L² are each as defined above, or together with R² form C₂-C₃-alkylene which may be substituted or unsubstituted by from one to three methyl groups, or C₂-C₃-alkenylene which may be substituted or unsubstituted by phenyl,

R⁴ is hydrogen, substituted or unsubstituted C₁-C₁₈-alkyl, C₂-C₁₈-alkenyl, nitro or a radical of the formula OL¹, NL¹L², COOL¹ or SO₂NL¹L², where L¹ and L² are each as defined above, and

R⁵ and R⁶ are each, independently of one another, hydrogen, substituted or unsubstituted C₁-C₁₈-alkyl, C₂-C₁₈-alkenyl, substituted or unsubstituted phenyl, nitro, formylamino, substituted or unsubstituted C₂-C₄-alkanoyl, formylamino substituted or unsubstituted C₂-C₄-alkanoylamino, benzoylamino or a radical of the formula OL¹, NL¹L², SO₂NL¹L², SO₂L³, COL¹ or COOL¹, where L¹ and L² are each as defined above and L³ is substituted or unsubstituted C₁-C₁₈-alkyl, C₃-C₁₈-alkenyl or substituted or unsubstituted phenyl,

with the proviso that at least one of the radicals R³, R⁵ and R⁷ is hydrogen,

from WO 95/07460, naphthylamines of the formula

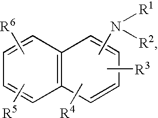

where R¹ and R² are each, independently of one another, hydrogen, C₁-C₁₈-alkyl which may be substituted or unsubstituted and may be interrupted by from 1 to 3 oxygen atoms as ether functions or by from 1 to 3 C₁-C₄-alkylimino groups, C₅-C₇-cycloalkyl, C₃-C₁₈-alkenyl, substituted or unsubstituted phenyl, or R¹ and R² together with the nitrogen atom connecting them form a 5- or 6-membered saturated heterocyclic radical which may contain a further heteroatom, and

R³, R⁴, R⁵ and R⁶ are each, independently of one another, hydrogen, C₁-C₈-alkyl, benzyl, cyano, nitro, C₁-C₄-alkanoyl, C₁-C₄-alkanoylamino, benzoylamino, hydroxysulfonyl or a radical of the formula OL¹, COOL¹, NL¹L² or CONL¹L², where L¹ and L² are each hydrogen, substituted or unsubstituted C₁-C₈-alkyl, C₅-C₇-cycloalkyl or substituted or unsubstituted phenyl, or R³ together with R² may form C₃-alkylene which may be unsubstituted or substituted by hydroxy, where, if the radicals NR¹R² and NL¹L² are in peri positions, R¹ and L¹ may also together form isopropylidene,

from WO 95/17483, azo dyes of the formula

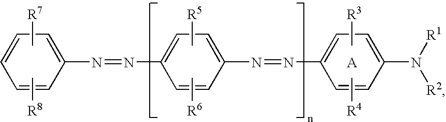

where the ring A may be benzo-fused,

n is zero or 1,

R¹ is hydrogen or C₁-C₁₅-alkyl which may be interrupted by from 1 to 4 oxygen atoms as ether functions,

R² is C₁-C₁₅-alkyl which may be interrupted by from 1 to 4 oxygen atoms as ether functions, or is a radical of the formula L-NX¹X², where L is C₂-C₈-alkylene and X¹ and X² are each, independently of one another, C₁-C₆-alkyl or together with the nitrogen atom connecting them may form a 5- or 6-membered saturated heterocyclic radical which may additionally contain an oxygen atom in the ring,

R³, R⁴, R⁵, R⁶ and R⁷ are each, independently of one another, hydrogen, C₁-C₁₅-alkyl or C₁-C₁₅-alkoxy and

R⁸ is hydrogen, C₁-C₁₅-alkyl, C₁-C₁₅-alkoxy, cyano, nitro or a radical of the formula COOX³, where X³ is hydrogen, C₁-C₁₅-alkyl which may be interrupted by from 1 to 4 oxygen atoms as ether functions, or is a radical of the formula L-NX¹X², where L, X¹ and X² are each as defined above,

from U.S. Pat. No. 4,209,302, naphthylamine derivatives selected from the group consisting of

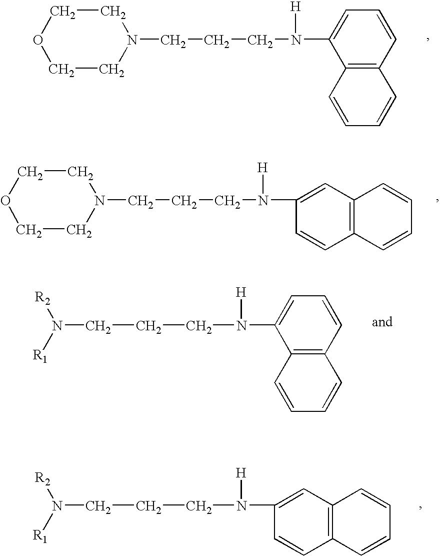

where R₁ and R₂ can each be hydrogen or alkyl having from one to 20 carbon atoms,

and from DE-A 2 129 590, azo compounds of the formula

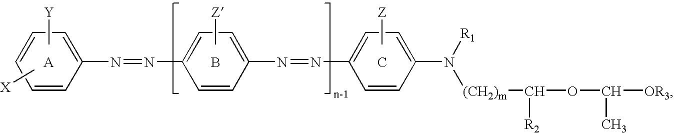

where m is from 1 to 3,

n is 1 or 2,

X is a hydrogen atom or a nitro group,

Y is hydrogen or chlorine atom, a nitro, lower alkyl or lower alkoxy group having from 1 to 3 carbon atoms,

Z and Z′ are each a hydrogen or chlorine atom, a lower alkyl or lower alkoxy group having from 1 to 3 carbon atoms or a lower acylamino group,

R₁ is an alkyl group or the group

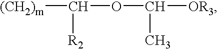

R₂ is a hydrogen atom or a lower alkyl group having from 1 to 3 carbon atoms and

R₃ is an alkyl group having from 1 to 18 carbon atoms or a cycloalkyl group,

where the aromatic rings A, B and C may bear further water-insoluble substituents.

Markers which can be extracted under basic conditions and can be used as possible first markers for the purposes of this embodiment of the present invention are described in the above-cited documents U.S. Pat. No. 3,764,273, U.S. Pat. No. 5,252,106, EP 0 509 818, WO 94/21752 and WO 95/10581.

In the following listing of basic-extractable markers, the definition of the respective variables has been adopted from the corresponding cited document for reasons of clarity. For specific meanings and preferred meanings of the variables, the disclosures of the respective documents are hereby expressly incorporated by reference.

Specific examples of possible basic-extractable markers are:

from U.S. Pat. No. 3,764,273, compounds selected from the group consisting of

Quinizarines of the formula

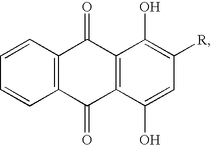

where R is an alkyl radical having from 1 to 20 carbon atoms or a furfuryl radical,

the azo dye of the formula

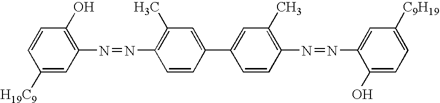

and the azo dye of the formula

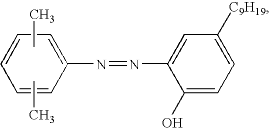

from U.S. Pat. No. 5,252,106, azo compounds of the formula

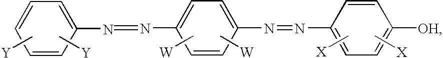

where the radicals W are selected from the group consisting of C₁-C₃-alkoxy and hydrogen, with the proviso that at least one radical W is C₁-C₃-alkoxy, and the radicals X and Y are identical or different and are selected from the group consisting of hydrogen, alkyl, substituted alkyl, alkenyl, substituted alkenyl, aryl, substituted aryl, fused aryl, substituted fused aryl, halogen, nitro, cyano and alkoxy,

from EP 0 509 818, azo compounds of the formula

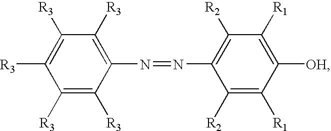

where the groups R₁ and R₂ are identical or different and are each hydrogen or a C₁-C₇-alkyl group, with at least one radical R₁ being a C₃-C₇-alkyl group, and the groups R₃ are identical or different and are each hydrogen, nitro, chlorine, bromine, fluorine, cyano, ethyl or methyl, with at least one R₃ being selected from among nitro, chlorine, bromine, fluorine and cyano,

from WO 94/21752, anthraquinones of the formula

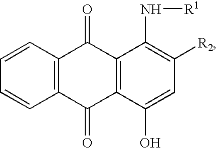

where R¹ is hydrogen, C₁-C₁₈-alkyl which may be unsubstituted or substituted by cyano, or phenyl which may be unsubstituted or substituted by C₁-C₄-alkyl, hydroxy or C₁-C₄-alkoxy, and

R² is hydrogen or a radical of the formula X-R³, where X is oxygen or sulfur and R³ is C₁-C₁₈-alkyl which may be unsubstituted or substituted by hydroxy, cyano or phenyl and may be interrupted by from 1 to 3 oxygen atoms as ether functions or by from 1 to 3 N-(C₁-C₄-alkyl)imino groups, or phenyl which may be unsubstituted or substituted by C₁-C₄-alkyl, hydroxy, C₁-C₄-alkoxy, (C₁-C₄-monocarbamoyl or dialkylcarbamoyl)-C₁-C₄-alkoxy or C₁-C₈-monoalkylsulfamoyl or dialkylsulfamoyl, where the alkyl groups here may be interrupted by from 1 to 3 oxygen atoms as ether functions,

and from WO 95/10581, azo dyes of the formula

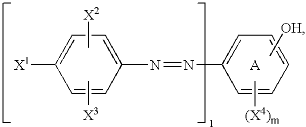

where the ring A may be benzo-fused and

l is 1 or 2,

m is from 1 to 4,

X¹ is hydrogen, C₁-C₄-alkyl, cyano, nitro or phenylazo which may be substituted or unsubstituted by one or two C₁-C₄-alkyl groups,

X² is hydrogen, C₁-C₄-alkyl, cyano, nitro, C₁-C₄-alkoxy or C₁-C₁₆-alkoxycarbonyl,

X³ is hydrogen, C₁-C₄-alkyl, cyano or C₁-C₁₆-alkoxycarbonyl and

X⁴ is hydrogen, hydroxy, C₁-C₈-alkyl which may be unsubstituted or substituted by phenyl, C₁-C₄-alkoxy, amino, C₁-C₄-dialkylamino or C₁-C₁₆-monoalkylamino whose alkyl chain may be interrupted by from 1 to 3 oxygen atoms as ether functions.

If, in this preferred embodiment, the first marker can be removed by means of aqueous acidic extractants, then the second marker cannot be removed completely by means of aqueous acidic extractants or both by means of aqueous acidic extractants and by means of aqueous basic extractants. In the latter case, the hydrocarbons marked by the method of the present invention can also not be freed of the second marker by means of a combination of aqueous acidic extraction and subsequent aqueous basic extraction. An analogous situation applies to the case of the first marker being able to be removed by means of aqueous basic extractants.

For the purposes of the present invention, an “aqueous” (acidic or basic) extractant is an extractant which has a water content higher than the sum of the customary (residual) water contents of its components.

In a particularly preferred embodiment of the method of the present invention, the second marker or markers can be removed completely from the hydrocarbons neither under acidic conditions nor under basic conditions or neither by means of aqueous acidic extractants nor by means of aqueous basic extractants.

Accordingly, this means that the hydrocarbons which have been marked in this way can be freed of the second marker neither by a combination of acidic and subsequent basic treatment nor by a combination of basic and subsequent acidic treatment or neither by a combination of aqueous acidic extraction and subsequent aqueous basic extraction nor by a combination of aqueous basic extraction and subsequent aqueous acidic extraction.

In the method of the present invention and its preferred and particularly preferred embodiments, preference is given to using second markers selected from the group consisting of the compounds of the formula Ia

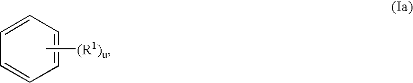

of the formula Ib

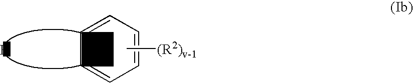

and of the formula Ic

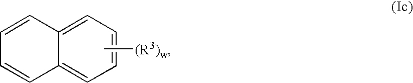

where the variables have the following meanings:

u, v and w are 1, 2 or 3,

R¹, R² and R³ are L, L-O—, L-O—C(O)—, R′₂N—C(O)—, R′—C(O)—, L-C(O)—O—, L-C(O)—NR′—, (L-C(O)-)₂N—, R′₂N—C(O)—NR′— or CN, where if u and w are greater than 1 and v is equal to 3, the radicals R¹, R³ and R² may in each case be identical or different,

L is C₁-C₂₀-alkyl, in which CH₂ groups may be replaced by oxygen atoms, with the proviso that at least two carbon atoms are in each case located between any such oxygen atoms and between any such oxygen atoms and any heteroatoms which may be bound to L, and/or in which nonadjacent CH₂ groups may be replaced by carbonyl groups, with the proviso that at least one CH or CH₂ group is located between any such carbonyl groups and any carbonyl groups bound to L

R′ is hydrogen or is as defined for L,

and R′ and L may, if they are present more than once in the radicals R¹, R² and/or R³, in each case be identical or different, and

K is C₃-C₅-alkylene in which a CH₂ group may be replaced by an oxygen atom and/or in which up to two nonadjacent CH₂ groups may be replaced by carbonyl groups.

Particular preference is given to using second markers selected from the group consisting of the compounds of the above formulae Ia, Ib and Ic in which

u, v and w are 1 or 2,

R¹, R² and R³ are L, L-O—, L-O—C(O)— or R′—C(O)—, where, if u and w are 2, the radicals R¹ and R³ may in each case be identical or different,

L is C₁-C₁₀-alkyl, in which CH₂ groups may be replaced by oxygen atoms, with the proviso that at least two carbon atoms are in each case located between any such oxygen atoms and between any such oxygen atoms and any heteroatoms which may be bound to L, and/or in which nonadjacent CH₂ groups may be replaced by carbonyl groups, with the proviso that at least one CH or CH₂ group is located between any such carbonyl groups and any carbonyl groups bound to L

R′ is hydrogen or is as defined for L and

K is C₃- or C₄-alkylene in which up to two nonadjacent CH₂ groups may be replaced by carbonyl groups.

C₁-C₂₀-Alkyl radicals L may be branched or unbranched alkyl chains such as methyl, ethyl, n-propyl, isopropyl, n-butyl, sec-butyl, isobutyl, tert-butyl, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-heptyl, n-octyl, 2-ethylhexyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl or n-eicosyl.

Examples of C₁-C₂₀-alkyl radicals L in which CH₂ groups may be replaced by oxygen atoms are —(CH₂—CH₂—O—)ₚH, —(CH₂-CH₂—O—)ₚCH₃, —(CH₂—CH(CH₃)—O—)_{q}H or —(CH₂—CH(CH₃)—O—)ᵣCH₃, where p is 1, 2, 3, 4, 5 or 6, q is 1, 2, 3, 4 or 5 and r is 1, 2, 3 or 4.

Suitable C₁-C₂₀-alkyl radicals L in which CH₂ groups may be replaced by oxygen atoms and carbonyl groups are —CH₂—O—C(O)—[(CH₂)ₛ]H and —CH₂—C(O)—O—[(CH₂)ₛ]H, where s can be an integer from 1 to 17.

Examples of radicals of the latter formulae are —CH₂—O—C(O)—CH₃ and —CH₂—C(O)—O—CH₃ (s=1 in each case) and —CH₂—O—C(O)—C₂H₅ and —CH₂—C(O)—O—C₂H₅ (s=2 in each case).

C₁-C₁₀-alkyl radicals which are particularly suitable as L are included in the above listings of examples of C₁-C₂₀-alkyl radicals.

Suitable C₃-C₅-alkylene radicals K in which a CH₂ group may be replaced by an oxygen atom and/or up to two nonadjacent CH₂ groups may be replaced by carbonyl groups are —(CH₂)₃—, —(CH₂)₄—, —(CH₂)₅—, —C(O)—O—C(O)—, —C(O)—CH₂—C(O)—, —C(O)—(CH₂)₂—C(O)—, —C(O)—(CH₂)₄—, —C(O)—(CH₂)₃—, —C(O)—(CH₂)₂—, —C(O)—(CH₂)₃—C(O)—, —O—(CH₂)₂—, —O—(CH₂)₃—, —O—(CH₂)₄—, —CH₂—O—CH₂—, —CH₂—O—(CH₂)₂—, —(CH₂)₂—O—(CH₂)₂—, —CH₂—O—(CH₂)₃—, —C(O)—O—CH₂—C(O)—, —C(O)—CH₂—O—CH₂—C(O)— or —C(O)—O—(CH₂)₂—C(O)—.

The C₃- or C₄-alkylene radicals which are particularly suitable as K are included in the above listing.

To mark the hydrocarbons, the first marker or markers and the second marker or markers are employed either as such or in the form of solutions. In the latter case, a total concentration of markers of from 20 to 80% by weight, based on the solution, is generally chosen.

Furthermore, the markers can also be present as components in “packages”, i.e. concentrated solutions of the dyes and/or markers used for coloring and/or marking. For the purposes of the present invention, such a package comprises not only the marker, i.e. the first marker, a (solvent) dye and a solvent but also at least one second marker as additional component. The packages customarily comprise from 10 to 20% by weight of first marker, from 5 to 25% by weight of second marker, from 10 to 20% by weight of (solvent) dye and, to make up the balance to 100% by weight, solvents.

The concentration figures given for the solutions and packages are applicable in normal cases. However, depending on the chemical nature of the specific components, the concentrations can go above or below the upper or lower limits for the dyes and markers. Furthermore, it is naturally also possible for lower values to have to be set for some of the components and higher values to be able to be set for the other components. The precise composition to be set can normally be determined easily by a person skilled in the art by means of routine preliminary tests.

Suitable solvents are organic solvents. Preference is given to using aromatic hydrocarbons such as toluene, xylene, dodecylbenzene, diisopropylnaphthalene or a mixture of higher aromatics which is available commercially under the name Shellsol® AB (from Shell).

It is also possible to use further cosolvents, e.g. alcohols such as methanol, ethanol, propanol, isopropanol, butanol, isobutanol, pentanol, hexanol, heptanol, octanol, 2-ethylhexanol or cyclohexanol, glycols such as butylethylene glycol or methylpropylene glycol, amines such as triethylamine, diisooctylamine, dicyclohexylamine, aniline, N-methylaniline, N,N-dimethylaniline, toluidine or xylidine, alkanolamines such as 3-(2-methoxyethoxy)propylamine, o-cresol, m-cresol, p-cresol, ketones such as diethyl ketone or cyclohexanone, lactones such as γ-butyrolactone, carbonates such as ethylene carbonate or propylene carbonate, phenols such as t-butylphenol or nonyl-phenol, esters such as methyl phthalate, ethyl phthalate, 2-ethylhexyl phthalate, ethyl acetate, butyl acetate or cyclohexyl acetate, amides such as N,N-dimethylformamide, N,N-diethylacetamide or N-methylpyrrolidinone, or mixtures thereof.

The marked hydrocarbons preferably have a total content of first and second markers of from 5 to 1 000 ppm, in particular from 10 to 1 000 ppm. Particular mention should be made of a content of from 10 to 500 ppm, in particular from 50 to 100 ppm.

In the context of the present invention, we also claim hydrocarbons which have been marked by the method of the present invention and its preferred and particularly preferred embodiments.

We also claim solutions for marking hydrocarbons which comprise at least one first marker and at least one second marker as defined in the method of the present invention and optionally further additives.

Such solutions, in particular for marking hydrocarbons, have already been described above without further additives being indicated.

Furthermore, such solutions also include the abovementioned “packages”, where the (solvent) dyes usually additionally present in these packages may be regarded as further additives.

In contrast, the cosolvents listed above by way of example are not to be regarded as further additives, but as additional solvents.

Further additives in such solutions are, for example, denaturants, fuel additives, specific stabilizers such as dispersants to prevent flocculation at low temperatures, etc.

### EXAMPLES

A) Examination of potential second markers

Substances corresponding to the above formulae Ia, Ib and Ic were examined as possible second marker(s) for hydrocarbons.

For this purpose, solutions of the substances in a concentration of 10 mg per kg, i.e. in a concentration of 10 ppm, in Shellsol® AB (from Shell) were prepared and examined by means of HPLC and UV detection (“standard sample”). This served firstly to answer the question as to whether components from the hydrocarbon interfere in the determination of the respective substance by means of a UV detector and secondly to determine whether the respective substance has a sufficient UV absorption.

Measurements were also carried out on samples of the marked hydrocarbon which had previously been treated with 50% strength aqueous sulfuric acid (“acidic extraction”) or 10% strength aqueous sodium hydroxide (“basic extraction”). The intention here was to determine whether the respective second marker was extracted from the hydrocarbon under aqueous acidic or aqueous basic conditions and, if so, how much marker remained.

The UV absorption or signal area (“SA”) in millivolt seconds for each substance at the appropriate wavelength λ (in nm) is reported in table 1 below.

TABLE 1

| | | | | SA | SA |
|---|---|---|---|---|---|
| | | | | after | after |
| | | | SA of | acidic | basic |
| | Structural | | standard | extrac- | extrac- |
| Substance | formula | λ | sample | tion | tion |
| Methyl benzoate | 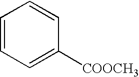 | 230 | 237 | 168 | 13 |
| Dimethyl phthalate | 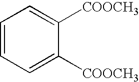 | 230 | 119 | 114 | 13 |
| Anisole (methoxybenzene) | 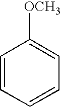 | 275 | 36 | 35 | 36 |
| Benzonitrile | 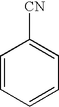 | 230 | 289 | 272 | 260 |
| Benzyl acetate | 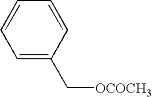 | 205 | 154 | 108 | <10 |
| Acetophenone | 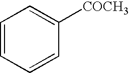 | 255 | 182 | 166 | 178 |
| 1-Acetylnaphthalene | 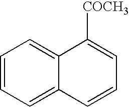 | 230 | 325 | 305 | 321 |
| Ethylbenzoyl- acetate | 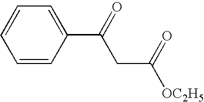 | 247 | 47 | 47 | 9 |
| 4-Methoxyaceto- phenone | 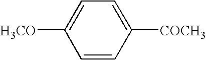 | 279 | 259 | 225 | 248 |
| 1,3-Indanedione | 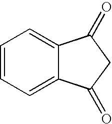 | 255 | 73 | 106 | <10 |

All the substances listed in table 1 are in principle suitable as second markers under these conditions, i.e. after acidic or basic extraction or after acidic extraction combined with basic extraction, since they can be recognized unambiguously in the presence of the constituents of the diesel fuel.

In the case of 1,3-indanedione, no precise concentration determination could be carried out because of its very low retention and unfavorable peak shape. This could explain why the signal area of the acid-extracted sample is higher than that of the standard sample.

In the case of the hydrocarbon samples marked with anisole, benzyl acetate and ethyl benzoylacetate, it has to be assumed that coelution with constituents occurs as a result of the relatively high hydrophobicity of the substances.

The remaining substances not only display suitable chromatographic behavior but their detection is very sensitive. This applies particularly to acetophenone, 4-methoxyacetophenone, benzonitrile and methyl benzoate, so that these compounds are particularly useful as second markers under these conditions.

we claim:

1. A method of marking hydrocarbons by addition of at least one first marker, wherein at least one second marker which cannot be removed completely from the hydrocarbons under the conditions of the removal of the first marker or markers is additionally added to the hydrocarbons.

2. A method as claimed in claim 1, wherein the absorption maximum of the second marker or markers is at a wavelength of less than 500 nm.

3. A method as claimed in claim 1 or 2, wherein the first marker or markers can be removed under acidic or basic conditions and the second marker or markers cannot be removed completely in a corresponding fashion under acidic or basic conditions or the second marker or markers can be removed completely from the hydrocarbons under neither acidic nor basic conditions.

4. A method as claimed in claim 1 or 2, wherein the first marker or markers can be removed by means of aqueous acidic or aqueous basic extractants and the second marker or markers cannot be removed completely in a corresponding fashion by means of aqueous acidic or aqueous basic extractants or the second marker or markers can be removed completely from the hydrocarbons neither by means of aqueous acidic extractants nor by means of aqueous basic extractants.

5. A method as claimed in claim 3 or 4, wherein the second marker or markers can be removed completely from the hydrocarbons neither under acidic conditions nor under basic conditions or neither by means of aqueous acidic extractants nor by means of aqueous basic extractants.

6. A method as claimed in one or more of claims 3 to 5, wherein the second marker or markers is/are selected from the group consisting of the compounds of the formula Ia 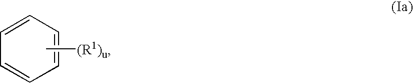
of the formula Ib 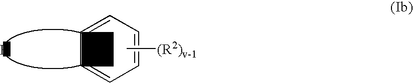
and of the formula Ic 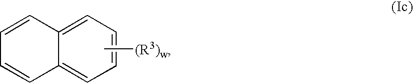
where the variables have the following meanings:
u, v and w are 1, 2 or 3,
R¹, R² and R³ are L, L-O—, L-O—C(O)—, R′₂N—C(O)—, R′—C(O)—, L-C(O)—O—, L-C(O) —NR′—, (L-C(O)—)₂N—, R′₂N—C(O)—NR′— or CN, where if u and w are greater than 1 and v is equal to 3, the radicals R¹, R³ and R² may in each case be identical or different,
L is C₁-C₂₀-alkyl, in which CH₂ groups may be replaced by oxygen atoms, with the proviso that at least two carbon atoms are in each case located between any such oxygen atoms and between any such oxygen atoms and any heteroatoms which may be bound to L, and/or in which nonadjacent CH₂ groups may be replaced by carbonyl groups, with the proviso that at least one CH or CH₂ group is located between any such carbonyl groups and any carbonyl groups bound to L
R′ is hydrogen or is as defined for L,
and R′ and L may, if they are present more than once in the radicals R¹, R² and/or R³, in each case be identical or different, and
K is C₃-C₅-alkylene in which a CH₂ group may be replaced by an oxygen atom and/or in which up to two nonadjacent CH₂ groups may be replaced by carbonyl groups.

7. A method as claimed in claim 6, wherein, in the formulae Ia, Ib and Ic,
u, v and w are 1 or 2,
R¹, R² and R³ are L, L-O—, L-O—C(O)— or R′—C(O)—, where, if u and w are 2, the radicals R¹ and R³ may in each case be identical or different,
L is C₁-C₁₀-alkyl, in which CH₂ groups may be replaced by oxygen atoms, with the proviso that at least two carbon atoms are in each case located between any such oxygen atoms and between any such oxygen atoms and any heteroatoms which may be bound to L, and/or in which nonadjacent CH₂ groups may be replaced by carbonyl groups, with the proviso that at least one CH or CH₂ group is located between any such carbonyl groups and any carbonyl groups bound to L
R′ is hydrogen or is as defined for L and
K is C₃- or C₄-alkylene in which up to two nonadjacent CH₂ groups may be replaced by carbonyl groups.

8. A hydrocarbon which has been marked by a method as claimed in any of claims 1 to 7.

9. A solution comprising as components
at least one solvent,
at least one first marker and at least one second marker as defined in the method as claimed in one or more of claims 1 to 7, and
if desired, further additives.
